(19) United States
(12) Patent Application Publication
(10) Pub. No.: US 2026/0369485 A1
(43) Pub. Date: Nov. 19, 2026

(54) REMOTELY ACTIVATED LOCKOUT/TAGOUT DEVICE

(71) Applicant: Eaton Intelligent Power Limited, Dublin (IE)

(72) Inventors: Robert Stephen Douglass, Wildwood, MO (US); Thomas Edward Schmitt, Collinsville, IL (US)

(21) Appl. No.: 19/209,193

(22) Filed: May 15, 2025

(51) Int. Cl. H01H 9/20; H01H 9/16

(52) U.S. Cl. CPC H01H 9/20; H01H 9/161

(57) ABSTRACT

In one embodiment, a remotely activated lockout/tagout device in an industrial system, the remotely activated lockout/tagout device comprising a switch that has a first state and a second state, wherein the switch is coupled to a device in the industrial system and a power supply system; a mechanical locking element that is disposed within a housing of the remotely activated lockout/tagout device, wherein the mechanical locking element is coupled to the switch; a lock actuator comprising a locking pin that is selectively controllable to interact with the mechanical locking element; and a control element that is communicatively coupled to the lock actuator and a remote device, the control element configured to receive a request to change a position of the locking pin from the remote device, wherein the request includes an identifier of the remotely activated lockout/tagout device and a requested position of the locking pin; and in response to request to change the position of the locking pin, activate the lock actuator to change positions of the locking pin with respect to the mechanical locking element.

### TECHNICAL FIELD

One technical field of the present disclosure is lockout/tagout devices, including remotely activated lockout/tagout devices.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Safety lockout/tagout procedures are in widespread use to ensure worker safety in the performance of otherwise hazardous tasks involving industrial systems and associated devices. For example, electrical power system lockout/tagout devices and processes ensure worker safety in completing maintenance tasks for an electrical power distribution system supplying power to electrical loads. In a typical lockout/tagout procedure, one or more electrical switching devices or disconnect devices in the electrical power system is opened at a pre-determined point or set of predetermined points to electrically isolate load-side circuits or devices (and connected electrical loads) from power supply-side circuitry. By electrically isolating load-side circuitry from the supply-side circuitry, maintenance tasks are able to be performed safely on the isolated (and de-energized) load-side of the system. To ensure that the electrical isolation of the load-side circuit is maintained, the predetermined points that are opened are physically locked, typically by a red padlock, to prevent the predetermined points from being re-closed.

While conventional lockout/tagout devices and procedures are effective to provide the desired worker safety, they are nonetheless disadvantaged in some aspects and improvements are desired.

### SUMMARY

In some aspects, the techniques described herein relate to a remotely activated lockout/tagout device in an industrial system, the remotely activated lockout/tagout device including: a switch that has a first state and a second state, wherein the switch is coupled to a device in the industrial system and a power supply system; a mechanical locking element that is disposed within a housing of the remotely activated lockout/tagout device, wherein the mechanical locking element is coupled to the switch; a lock actuator including a locking pin that is selectively controllable to interact with the mechanical locking element; and a control element that is communicatively coupled to the lock actuator and a remote device, the control element configured to: receive a request to change a position of the locking pin from the remote device, wherein the request includes an identifier of the remotely activated lockout/tagout device and a requested position of the locking pin; and in response to request to change the position of the locking pin, activate the lock actuator to change positions of the locking pin with respect to the mechanical locking element.

In some aspects, the techniques described herein relate to a remotely activated lockout/tagout device further including a lockout status indicator that visually presents a lockout status of the remotely activated lockout/tagout device.

In some aspects, the techniques described herein relate to a remotely activated lockout/tagout device wherein the lockout status indicator is a light emitting diode (LED).

In some aspects, the techniques described herein relate to a remotely activated lockout/tagout device, wherein the locking pin has a first position that prevents the switch from electrically connecting one or more circuits of the device of the industrial system to one or more circuits of the power supply system.

In some aspects, the techniques described herein relate to a remotely activated lockout/tagout device, wherein the first position of the mechanical locking element includes the locking pin protruding into a recess of the mechanical locking element.

In some aspects, the techniques described herein relate to a remotely activated lockout/tagout device, wherein the locking pin has a second position that prohibits the switch from electrically disconnecting one or more circuits of the device of the industrial system to one or more circuits of the power supply system.

In some aspects, the techniques described herein relate to a remotely activated lockout/tagout device, wherein the control element is further configured to: receive a second request from the remote device, wherein the second request includes a second identifier and a second requested position of the locking pin; and in response to the second request, determine that the second request is an update to the first request; and activate the lock actuator to change positions of the locking pin with respect to the mechanical locking element.

In some aspects, the techniques described herein relate to a remotely activated lockout/tagout device, wherein the control element is further configured to: receive a second request from the remote device, wherein the second request includes a second identifier and a second requested position of the locking pin; and in response to the second request, determine that the second request is not an update to the first request; and restrict the lock actuator from changing positions of the locking pin with respect to the mechanical locking element.

### BRIEF DESCRIPTION OF THE DRAWINGS

In the drawings:

FIG. 1A illustrates a perspective view of a lockout/tagout device in accordance with one or more embodiments of the present disclosure.

FIG. 1B illustrates a perspective view lockout/tagout device in accordance with one or more embodiments of the present disclosure.

FIG. 1C illustrates a perspective view lockout/tagout device in accordance with one or more embodiments of the present disclosure.

FIG. 2A illustrates a cutaway side view of a lockout/tagout device in accordance with one or more embodiments of the present disclosure.

FIG. 2B illustrates a front view lockout/tagout device in accordance with one or more embodiments of the present disclosure.

FIG. 2C illustrates a back view lockout/tagout device in accordance with one or more embodiments of the present disclosure.

FIG. 2D illustrates a top-down view lockout/tagout device in accordance with one or more embodiments of the present disclosure.

FIG. 2E illustrates a bottom-up view lockout/tagout device in accordance with one or more embodiments of the present disclosure.

FIG. 3A illustrates a cutaway view of a lockout/tagout device that is in an unlocked state in accordance with one or more embodiments of the present disclosure.

FIG. 3B illustrates a cutaway view of a lockout/tagout device that is in a locked-on state in accordance with one or more embodiments of the present disclosure.

FIG. 4A illustrates a cutaway view of a lockout/tagout device that is in an unlocked state in accordance with one or more embodiments of the present disclosure.

FIG. 4B illustrates a cutaway view of a lockout/tagout device that is in a lockout state in accordance with one or more embodiments of the present disclosure.

### DETAILED DESCRIPTION

In the following description, for the purposes of explanation, numerous specific details are set forth in order to provide a thorough understanding of the present disclosure. It will be apparent, however, that the present disclosure may be performed without these specific details. In other instances, well-known structures and devices are shown in block diagram form in order to avoid unnecessarily obscuring the present disclosure.

The text of this disclosure, in combination with the drawing figures, is intended to state in prose the mechanical and control components that are necessary to provide a lockout system in such a way as to implement the system of the disclosure, at the same level of detail that is used by people of skill in the arts to which this disclosure pertains to communicate. That is, the level of detail set forth in this disclosure is the same level of detail that persons of skill in the art normally use to communicate with one another to express algorithms to be programmed or the structure and function of programs to implement the systems and methods disclosed herein.

Typical lockout/tagout mechanisms and methods use mechanical locking devices (e.g., a red painted padlock) that have individualized keys, which provide worker safety in the maintenance of industrial systems. However, typical lock and key systems create inefficiencies in logistical aspects (e.g., having to have personnel with the appropriate key physically be present at the lock for locking/unlocking). In an electrical power system context, to provide assurance that electrical isolation (between supply side and load-side) is maintained while maintenance or other operations are being performed on the load-side, a padlock may be installed to switches or circuit breaker devices to physically prevent them from changing positions (i.e., mechanically retaining electrical contacts in a de-energized position to electrically isolate the load-side from the supply side), thereby preventing them from being re-energized. In some cases, more than one member of the safety personnel may place padlocks to ensure that various components of the industrial system remain isolated until each component is repaired, inspected, or ready to be reenergized. Visually perceivable notifications (e.g., such as visual tags) may be coupled to the padlocks to notify other personnel of the lockout condition and to reduce any possible removal of the padlocks resulting in an unauthorized reenergization of the industrial system. The visual notifications may identify a specific member of the safety personnel to whom the padlock belongs. Keys to unlock the padlocks for removal may be limited to only authorized trained workers who can verify the safety of the industrial system and any maintenance personnel before electrical power is restored.

Using typical padlock lockout/tagout procedures, safety personnel may possess a unique mechanical lock and key combination, with each mechanical lock being installed by a particular member of the safety personnel at the designated lockout location. By using this approach, each member of the safety personnel can remove their own mechanical lock, but not the mechanical lock of another person. As such, multiple people are required to remove the multiple mechanical locks before the switch device can be re-energized as each different lock requires a separate key and authorized user. A secure lockout/tagout safety chain may include numerous locks and creates a number of difficult logistical issues with managing the lockout process.

For instance, as applied to industrial sized power systems having an extensive amount of lockout locations, the logistical challenges of tracking a lock and key inventory such that each key and lock corresponds to only a single member of safety personnel are substantial. Given that multiple locks may be used in single lockout location, the lock and key inventory becomes even more significant, which creates a risk of violating a safety chain.

The issues above are exacerbated as the number of workers involved in the lockout/tagout safety chain increases, with each added person incrementally increasing a chance that completion or removal of the safety lockout chain will incur an undesirable delay. Improvements to controlling and remotely managing lockout/tagout procedures while preserving the safety and visual clarity for maintenance personnel of which circuits are electrically isolated is needed.

In various embodiments, the disclosure encompasses the subject matter of the following numbered clauses:
1. A remotely activated lockout/tagout device in an industrial system, the remotely activated lockout/tagout device comprising: a switch that has a first state and a second state, wherein the switch is coupled to a device in the industrial system and a power supply system; a mechanical locking element that is disposed within a housing of the remotely activated lockout/tagout device, wherein the mechanical locking element is coupled to the switch; a lock actuator comprising a locking pin that is selectively controllable to interact with the mechanical locking element; and a control element that is communicatively coupled to the lock actuator and a remote device, the control element configured to: receive a request to change a position of the locking pin from the remote device, wherein the request includes an identifier of the remotely activated lockout/tagout device and a requested position of the locking pin; and in response to request to change the position of the locking pin, activate the lock actuator to change positions of the locking pin with respect to the mechanical locking element.
2. The remotely activated lockout/tagout device of claim 1 further comprising a lockout status indicator that visually presents a lockout status of the remotely activated lockout/tagout device.
3. The remotely activated lockout/tagout device of claim 1 wherein the lockout status indicator is a light emitting diode (LED).
4. The remotely activated lockout/tagout device of claim 1, wherein the locking pin has a first position that prevents the switch from electrically connecting one or more circuits of the device of the industrial system to one or more circuits of the power supply system.
5. The remotely activated lockout/tagout device of claim 4, wherein the first position of the mechanical locking element comprises the locking pin protruding into a recess of the mechanical locking element.
6. The remotely activated lockout/tagout device of claim 1, wherein the locking pin has a second position that prohibits the switch from electrically disconnecting one or more circuits of the device of the industrial system to one or more circuits of the power supply system.
7. The remotely activated lockout/tagout device of claim 1, wherein the control element is further configured to: receive a second request from the remote device, wherein the second request includes a second identifier and a second requested position of the locking pin; and in response to the second request, determine that the second request is an update to the first request; and activate the lock actuator to change positions of the locking pin with respect to the mechanical locking element.
8. The remotely activated lockout/tagout device of claim 1, wherein the control element is further configured to: receive a second request from the remote device, wherein the second request includes a second identifier and a second requested position of the locking pin; in response to the second request, determine that the second request is not an update to the first request; and restrict the lock actuator from changing positions of the locking pin with respect to the mechanical locking element.

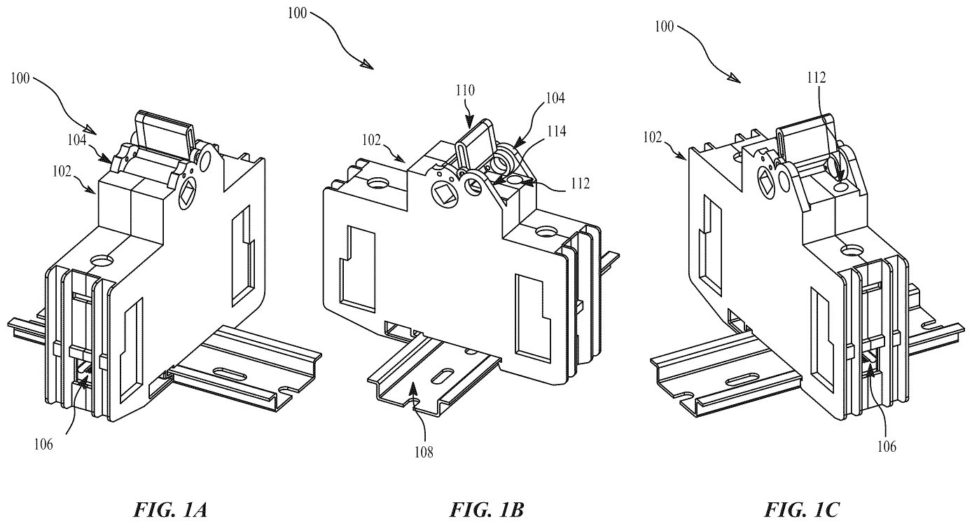

Turning now to the figures, FIGS. 1A-1C illustrate a perspective view of a lockout/tagout device in accordance with one or more embodiments of the present disclosure. In an embodiment, a lockout device 100 comprises components such as housing 102, mechanical locking port 104, wiring port 106, mounting rail 108, and switch handle 110, a lockout status indicator 112, and additional external locking port 114.

As shown in FIG. 1, the lockout device 100 may have a padlock connected to the mechanical locking port 104 that prevents the switch handle 110 from changing positions. The insertion of a padlock (or portion of a padlock) mechanically retains the switch handle 110 in the off position. While not shown in FIGS. 1A-1C, the switch handle 110 in the off position prevents connection between a load-side circuit and a supply side circuit, which may be controlled by a mechanical control that connects or disconnects the wire contacts.

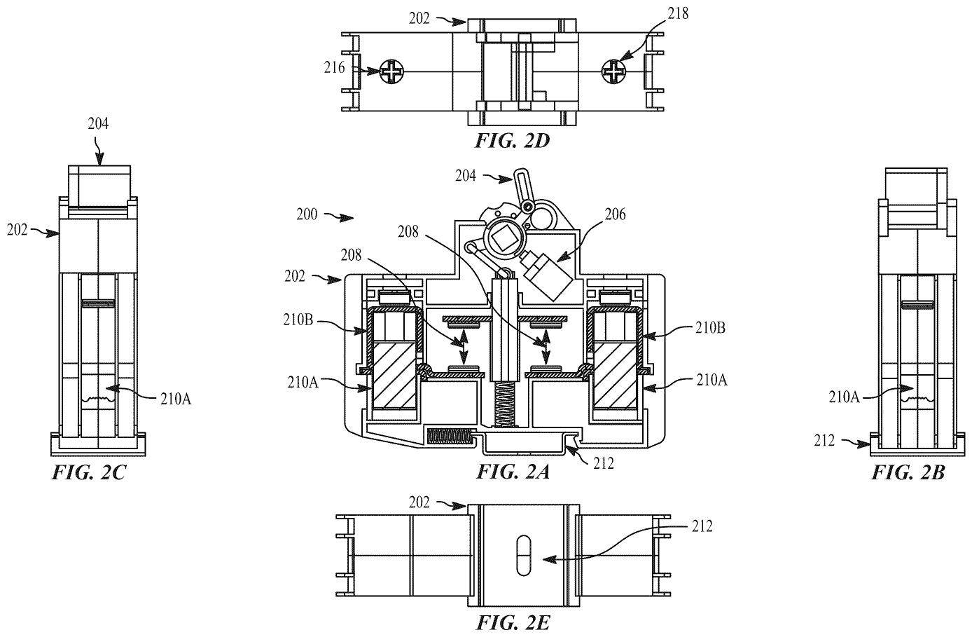

FIG. 2A illustrates a cutaway side view of a lockout/tagout device in accordance with one or more embodiments of the present disclosure. As illustrated by FIG. 2A, the lockout device 200 includes a housing 202, switch 204, a solenoid control 206, an isolation gap 208, wire connection zones 210A and 210B, mounting rail 212, and an external locking port 214.

The housing 202 is formed such that it mechanically secures or contains the solenoid control 206, an isolation gap 208, wire connection zones 210A and 210B. The housing 202 may include a passage such that the switch 204 can be mechanically or electromechanically coupled to the solenoid control 206 and such that the switch 204 may extend outside of the housing. In some embodiments, the switch 204 may be a two-position switch such that in a first position, the switch 204 is coupled electromechanically to retain the isolation gap 208 (e.g., a de-energized or “off” position). In some embodiments, the switch 204 may be configured in a second position, in which the switch 204 electromechanically closes the isolation gap 208 (e.g., after which, the switch is in an energized or “on” position). In the second position of the switch 204, the wire connection zones 210A and/or 210B are closed and the closed connection provides an electrical connection between the load-side circuit and the supply-side circuit. The housing 202 may further be attachable to the mounting rail 212 such as for inclusion in an industrial device, or a breaker panel, or the like.

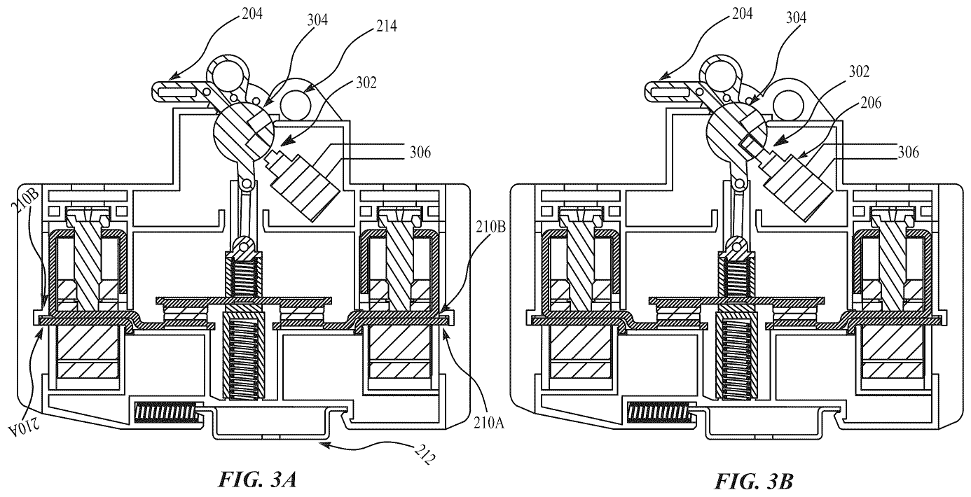

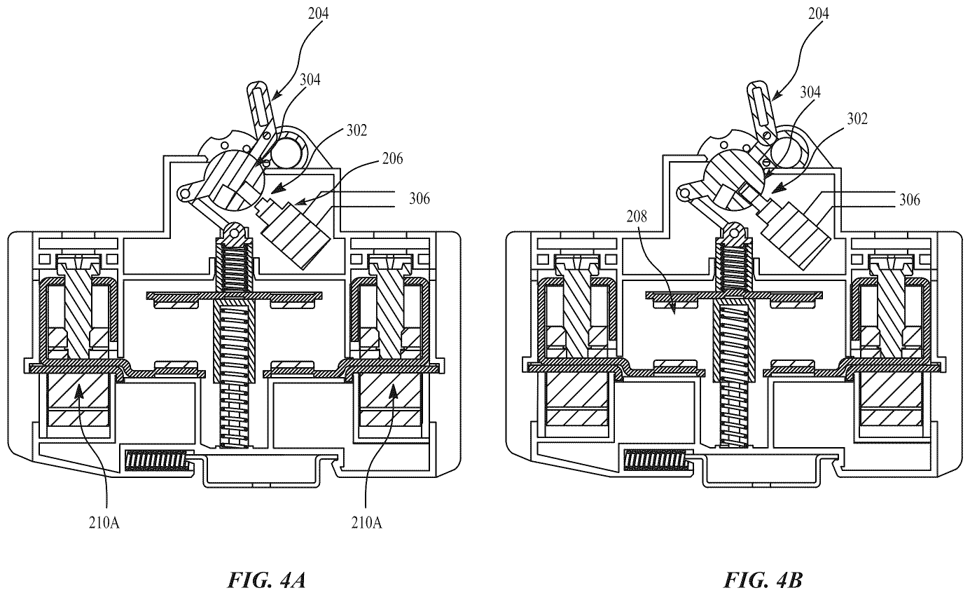

FIG. 2B illustrates a front view lockout/tagout device in accordance with one or more embodiments of the present disclosure. Similar to as shown in FIG. 2A, the wire connection zones 210A and/or 210B and the mounting rail 212 are visible. FIG. 2B further illustrates the switch 204 that extends externally from the top of the housing 202. FIG. 2C illustrates a back view lockout/tagout device in accordance with one or more embodiments of the present disclosure. Similar to as shown in FIG. 2B, the wire connection zones 210A and/or 210B and the mounting rail 212 are visible. FIG. 2B further illustrates the switch 204 that extends externally from the top of the housing 202. FIG. 2D illustrates a top-down view lockout/tagout device in accordance with one or more embodiments of the present disclosure. As illustrated in FIG. 2D, a top surface of the housing 202 may include a first wire screw position 216 and/or a second wire screw position 218. FIG. 2E illustrates a bottom-up view lockout/tagout device in accordance with one or more embodiments of the present disclosure. From the bottom-up perspective, the housing 202 and the mounting rail 212 are visible. Additional details relating to the solenoid control 206 are described with reference to FIGS. 3A-4B.

FIG. 3A illustrates a cutaway view of a lockout/tagout device that is in an unlocked state in accordance with one or more embodiments of the present disclosure. As illustrated by FIG. 3A, the lockout device 200 includes a housing 202, switch 204, a mechanical locking mechanism 304, a solenoid control 206,, wire connection zones 210A and 210B, mounting rail 212, an external locking port 214, and solenoid power wiring 306. Specifically, FIG. 3A depicts the solenoid control 206 in an unlocked state which is defined by a state of a locking pin 302 being positioned to allow movement of the switch 204.

Similar to as described above, the housing 202 mechanically encloses the solenoid control 206, wire connection zones 210A and 210B. The housing 202 may include a passage such that the switch 204 can be mechanically or electromechanically coupled to the solenoid control 206 and such that the switch 204 may extend outside of the housing. In some embodiments, the switch 204 may be a two-position switch such that in a first position, the switch 204 is coupled electromechanically to retain the isolation gap 208 (e.g., a de-energized or “off” position). In some embodiments, the switch 204 may be configured in a second position, with the second position of the switch 204 electromechanically closes the isolation gap 208 (e.g., after which, the switch is in an energized or “on” position). In the second position of the switch 204, the wire connection zones 210A and/or 210B are closed and the closed connection provides an electrical connection between the load-side circuit and the supply-side circuit. The housing 202 may further be attachable to the mounting rail 212 such as for inclusion in an industrial device, or a breaker panel, or the like.

In some examples, the solenoid control 206 may be communicatively coupled to a processor that communicates using one or more wired/wireless protocols to receive requests to lock or unlock. The combination of the solenoid control 206 and the locking pin 302 may be referred to together as a “lock actuator” that is selectively controllable to adjust a position of the locking pin 302 to interact with the mechanical locking mechanism 304. In some embodiments, the lock actuator may be coupled to a control element, such as a processor that is configured to receive a request to change a position of the locking pin from the remote device. The request may be a message transmitted across a communication system such as the internet, wireless connection, or wired connection. The request includes an identifier of the remotely activated lockout/tagout device 200 and a requested position of the locking pin 302 (e.g., a first position or a second position). The identifier may be a serial number of the lockout device 200, a unique key that identifies the lockout device 200 and a location within the industrial system (e.g., a circuit identifier that corresponds to the circuit being electrically isolated). In some embodiments, the locking pin 302 may be activated using various actuating mechanisms such as a spring, pneumatic, hydraulic, or electric motor, or the like.

In some embodiments, the mechanical locking mechanism 304 may include a sensor that monitors the position of the solenoid and determine whether the solenoid is fully retracted, fully extended, or in some intermediate position. The sensor may be configured to determine whether an intermediate position of the solenoid is operable to lock the mechanical locking mechanism 304 with the locking pin 302. In some embodiments, some requests may be from an administrative user of the safety personnel and may provide an override function for the lockout device 200. For these administrative requests, there may be an additional security measure such as a password, an NFC tag, or two-factor authentication.

In some embodiments, the lock actuator may include multiple solenoids and multiple locking pins such that each combination of solenoid and locking pin correspond to a member of safety personnel. The mechanical locking mechanism 304 may have multiple recesses to accept each respective locking pin. This configuration provides multiple members of safety personnel can request a lockout/tagout. The first request may activate a first solenoid, and a first locking pin and subsequent requests may activate a respective next solenoid and respective next locking pin. In some applications, if multiple requests have been made to lockout the circuit, then all requests must have a corresponding unlock request before the respective next solenoid will unlock. In other applications, each locking pin and the corresponding recess in the mechanical locking mechanism 304 may have unique shapes such that there is a one-to-one correspondence between a particular locking pin and a recess in the mechanical locking mechanism 304.

In some embodiments, a portion of the solenoid may extend to the exterior of the housing to indicate a position of the solenoid (electrical isolation). In other embodiments, the portion of the solenoid may be disposed in a position such that a transparent portion of the housing provides a visual indication of the position of the solenoid. In yet other embodiments, an LED or other visual indicator can provide an indication of the solenoid position.

In response to request to change the position of the locking pin the control element activates the lock actuator to change positions of the locking pin 302 with respect to the mechanical locking element. As illustrated in FIG. 3B in comparison with FIG. 3A, the locking pin 302 is in the second position that prevents the movement of the mechanical locking mechanism 304, and accordingly, prevents the switch from being moved. In FIG. 3B, the lockout device 200 has the switch 204 locked in the “ON” or energized state. For example, the lockout device 200 may be locked in an energized state for critical infrastructure industrial systems such as fire suppression, emergency response, or other electrical systems which need to continue to be energized during emergency or abnormal operation conditions.

In some embodiments, the control element may be incorporated into the solenoid control 206 using an embedded processor or other control circuit. The control element may also be configured to deconflict multiple requests received from various devices used by respective members of the safety personnel. For example, the control element may activate the lockout device 200 to electrically isolate the load-side circuit from the supply-side circuit after receiving a first request from a first user device and retain the lockout status of electrically isolated until a corresponding unlock request is received from the first user device. In some cases, the control element may receive more than one request to activate the lockout device 200 from one or more user devices. The control element may require a quorum, up to and including all user devices, of requests to unlock the lockout device 200 before unlocking the switch 204.

As further illustrated in FIG. 3B, the second position of the switch 204 electromechanically closes the isolation gap 208 (e.g., maintaining an energized or “on” position). In the second position of the switch 204, the wire connection zones 210A and/or 210B provide an electrical connection between the load-side circuit and the supply-side circuit. In combination with the second position of the locking pin 302 that protrudes from the solenoid control 206 into the mechanical locking mechanism 304, the switch 204 is prevented from changing positions.

In some embodiments, the mechanical locking mechanism 304 may have different shapes that correspond with a shape of the locking pin 302 (e.g., a cylinder, rectangular, etc.) such that the shape of the locking pin 302 is complementary to a shape of a recess in the mechanical locking mechanism 304. In other embodiments, the mechanical locking mechanism 304 may have multiple recesses, such as a first recess for an “energized” position and a second recess for an “electrically isolated” position. The mechanical locking mechanism 304 may be configurable to be locked into either the first position or the second position.

In some instances, the lockout device 200 may indicate visually that position of the locking pin 302 by a lockout status indicator that may be a light emitting diode (LED). The lockout status indicator may be activated by a logic circuit that monitors the position of the lockout pin such that the LED illuminates when the locking pin is in the second position (e.g., locked) and the stops illuminating when the locking pin is in the first position (e.g., unlocked). In some embodiments, the lockout device 200 may be configured with multiple LEDs to indicate each of the multiple safety personnels that may have engaged in locking out the lockout device 200 (e.g., 2-10 or more LEDs). In such embodiments, the LEDs may be configured to indicate the order, or priority, of the safety personnels that is required to unlock the lockout device 200. For example, the LEDs may be marked with a numerical order to indicate such order or priority.

Turning to FIGS. 4A-4B, FIG. 4A illustrates a cutaway view of a lockout/tagout device that is in an unlocked state in accordance with one or more embodiments of the present disclosure. Similar to as illustrated by FIG. 3A and described above, the lockout device 200 illustrated by FIG. 4A is in an unlocked state in accordance with one or more embodiments of the present disclosure. As described above, the locking pin 302 is positioned to enable movement of the mechanical locking mechanism 304 and accordingly the switch 204. In FIG. 4B, in comparison with FIG. 4A, the locking pin 302 is in the second position that prevents the movement of the mechanical locking mechanism 304, and accordingly, prevents the switch from changing states. In FIG. 4B, the lockout device 200 has the switch 204 locked in the “OFF” or de-energized state. For example, the lockout device 200 may be locked in a de-energized state for non-critical infrastructure industrial systems which need to remain electrically isolated/disconnected during maintenance or repair operations.

As further illustrated in FIG. 4B, the first position of the switch 204 electromechanically opens the isolation gap 208 (e.g., maintaining a de-energized or “off” position). In the second position of the switch 204, the wire connection zones 210A and/or 210B provide an electrical connection between the load-side circuit and the supply-side circuit. In combination with the second position of the locking pin 302 that protrudes from the solenoid control 206 into the mechanical locking mechanism 304, the switch 204 is prevented from changing positions.

According to some embodiments, the techniques described herein are implemented by at least one computing device such as described with reference to the solenoid control 206 or other components. The techniques may be implemented in whole or in part using a combination of at least one server computer and/or other computing devices that are coupled using a network, such as a packet data network. The control devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such control devices may also combine custom hard-wired logic, ASICs, or FPGAs with custom programming to accomplish the described techniques.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A remotely activated lockout/tagout device in an industrial system, the remotely activated lockout/tagout device comprising:
a switch that has a first state and a second state, wherein the switch is coupled to a device in the industrial system and a power supply system;
a mechanical locking element that is disposed within a housing of the remotely activated lockout/tagout device, wherein the mechanical locking element is coupled to the switch;
a lock actuator comprising a locking pin that is selectively controllable to interact with the mechanical locking element; and
a control element that is communicatively coupled to the lock actuator and a remote device, the control element configured to:
receive a request to change a position of the locking pin from the remote device, wherein the request includes an identifier of the remotely activated lockout/tagout device and a requested position of the locking pin; and
in response to request to change the position of the locking pin, activate the lock actuator to change positions of the locking pin with respect to the mechanical locking element.

2. The remotely activated lockout/tagout device of claim 1 further comprising a lockout status indicator that visually presents a lockout status of the remotely activated lockout/tagout device.

3. The remotely activated lockout/tagout device of claim 2 wherein the lockout status indicator is a light emitting diode (LED).

4. The remotely activated lockout/tagout device of claim 1, wherein the locking pin has a first position that prevents the switch from electrically connecting one or more circuits of the device of the industrial system to one or more circuits of the power supply system.

5. The remotely activated lockout/tagout device of claim 4, wherein the first position of the mechanical locking element comprises the locking pin protruding into a recess of the mechanical locking element.

6. The remotely activated lockout/tagout device of claim 1, wherein the locking pin has a second position that prohibits the switch from electrically disconnecting one or more circuits of the device of the industrial system to one or more circuits of the power supply system.

7. The remotely activated lockout/tagout device of claim 1, wherein the control element is further configured to:
receive a second request from the remote device, wherein the second request includes a second identifier and a second requested position of the locking pin;
in response to the second request, determine that the second request is an update to the first request; and
activate the lock actuator to change positions of the locking pin with respect to the mechanical locking element.

8. The remotely activated lockout/tagout device of claim 1, wherein the control element is further configured to:
receive a second request from the remote device, wherein the second request includes a second identifier and a second requested position of the locking pin;
in response to the second request, determine that the second request is not an update to the first request; and
restrict the lock actuator from changing positions of the locking pin with respect to the mechanical locking element.
